(19) United States
(12) Patent Application Publication
(10) Pub. No.: US 2022/0339878 A1
(43) Pub. Date: Oct. 27, 2022

(54) FOUR MODE ADDITIVE MANUFACTURING MACHINE

(71) Applicant: Essentium, Inc., Pflugerville, TX (US)

(72) Inventors: Jason Greene, Huntington Beach, CA (US); Yasushi Mizuno, Houston, TX (US)

(21) Appl. No.: 17/238,557

(22) Filed: Apr. 23, 2021

(51) Int. Cl. B29C 64/393; B29C 64/236; B29C 64/25; B33Y 30/00; B33Y 50/02; B29C 64/209; B33Y 10/00

(52) U.S. Cl. CPC B29C 64/393; B29C 64/236; B29C 64/25; B33Y 30/00; B33Y 50/02; B29C 64/209; B33Y 10/00

(57) ABSTRACT

A machine for producing additive printed parts includes a first print head supported on a first gantry assembly, the first gantry assembly supported within the machine and adapted to selectively move horizontally back and forth along an x-axis, the first print head adapted to selectively move horizontally back and forth on the first gantry assembly along a y-axis, and a second print head supported on a second gantry assembly, the second gantry assembly supported within the machine and adapted to selectively move horizontally back and forth along the x-axis, the second print head adapted to selectively move horizontally back and forth on the first gantry assembly along the y-axis, wherein, the first and second print heads are independently moveable along both the x-axis and the y-axis.

### INTRODUCTION

The present disclosure relates to an additive manufacturing machine having two print heads. More particularly, the present disclosure describes an additive manufacturing machine having two print heads that are independently moveable within the additive manufacturing machine along both an x-axis and a y-axis.

Generally, an additive manufacturing machine includes a single print head that moves back and forth horizontally along an x-axis and a y-axis within the additive manufacturing machine. Some machines have been developed that include two print heads. In these machines, the print heads are mounted onto a common gantry that moves horizontally back and forth along a y-axis. The two print heads are independently moveable relative to one another along the gantry, but are not independently moveable along the x-axis, as they are both mounted onto the common gantry.

As additive manufacturing processes become more common, it becomes more and more important to be flexible and quick. Machines that can adapt to multiple modes of operation, and operate more efficiently and quickly than others will have an advantage.

Thus, while current additive manufacturing machines achieve their intended purpose, there is a need for a new and improved additive manufacturing machine that includes two print heads that are independently horizontally moveable along both an x-axis and a y-axis.

### SUMMARY

According to several aspects of the present disclosure, a machine for producing additive printed parts, includes a first print head supported on a first gantry assembly and a second print head supported on a second gantry assembly, wherein, the first and second print heads are independently moveable along both an x-axis and a y-axis.

According to another aspect, each of the first and second gantry assemblies are supported within the machine and adapted to independently and selectively move horizontally back and forth along the x-axis.

According to another aspect, the first print head is adapted to selectively move horizontally back and forth on the first gantry assembly along the y-axis, and the second print head is adapted to selectively move horizontally back and forth on the second gantry assembly along the y-axis.

According to another aspect, the machine further includes a generally rectangular horizontal frame including a front member, a rear member, a first side member, a second side member, a first gantry support rail mounted horizontally to the rear member adjacent and parallel to the rear member and a second gantry support rail mounted horizontally to the front member adjacent and parallel to the front member, each of the first and second gantry assemblies supported on the first and second gantry support rails.

According to another aspect, each of the first and second gantry assemblies includes a first support bracket attached to a first distal end and a second support bracket attached to a second distal end, the first and second support brackets of each of the first and second gantry assemblies adapted to support the first and second gantry assemblies on the first and second gantry support rails for horizontal movement within the machine along the x-axis.

According to another aspect, the first gantry assembly includes an encoder strip and linear rails mounted thereon, the linear rails adapted to support the first print head on the first gantry assembly for horizontal movement on the first gantry assembly along the y-axis and the encoder strip adapted to detect the position of the first print head on the first gantry assembly, and the second gantry assembly includes an encoder strip and linear rails mounted thereon, the linear rails adapted to support the second print head on the second gantry assembly for horizontal movement on the second gantry assembly along the y-axis and the encoder strip is adapted to detect the position of the second print head on the second gantry assembly.

According to another aspect, the machine further includes a plurality of bellows adapted to allow the first and second print heads to move horizontally on the first and second gantry assemblies along the y-axis and to allow the first and second gantry assemblies to move horizontally on the first and second gantry support rails along the x-axis, the plurality of bellows defining an upper surface of a build volume within the machine.

According to another aspect, the plurality of bellows includes a first bellow extending between the first gantry assembly and the first side member, a second bellow extending between the first and second gantry assemblies, a third bellow extending between the second gantry assembly and the second side member, a fourth bellow extending between the first print head and a first end of the first gantry assembly, a fifth bellow extending between the first print head and a second end of the first gantry assembly, a sixth bellow extending between the second print head and a first end of the second gantry assembly, and a seventh bellow extending between the second print head and a second end of the second gantry assembly.

According to another aspect, each of the first, second, third, fourth, fifth, sixth and seventh bellows is adapted to expand and compress to accommodate horizontal movement of the first and second print heads and the first and second gantry assemblies.

According to another aspect, each of the first, second, third, fourth, fifth, sixth and seventh bellows is an accordion structure comprising a plurality of rigid segments flexibly connected to one another at opposing ends.

According to another aspect, the machine further includes a controller adapted to control movement of the first and second gantry assemblies back and forth on the first and second gantry support rails along the x-axis, and movement of the first and second print heads back and forth on the first and second gantry assemblies along the y-axis.

According to another aspect, the controller is adapted to control movement of the first and second gantry assemblies and the first and second print heads in one of a first, second, third and fourth mode of operation.

According to another aspect, when operating in a first mode of operation, the controller is adapted to control movement of the first gantry assembly and the first print head while the second gantry assembly and the second print head are idle, and to control movement of the second gantry assembly and the second print head while the first gantry assembly and the first print head are idle to create a single part.

According to another aspect, when operating in a second mode of operation, the controller is adapted to control movement of the first gantry assembly and the first print head to create a first part, and to simultaneously control movement of the second gantry assembly and second print head to create a second part, wherein the first and second parts are identical.

According to another aspect, when operating in a third mode of operation, the controller is adapted to control movement of the first gantry assembly and the first print head to create a first part, and to simultaneously control movement of the second gantry assembly and second print head to create a second part, wherein the first and second parts are different.

According to another aspect, when operating in a fourth mode of operation, the controller is adapted to simultaneously control movement of the first and second gantry assemblies and the first and second print heads to create a single part.

According to several aspects of the present disclosure, a method of operating a machine for producing additive printed parts includes actuating, via a controller, a first print head, wherein the first print head is supported on a first gantry assembly, the first gantry assembly supported within the machine and adapted to selectively move horizontally back and forth along an x-axis, the first print head adapted to selectively move horizontally back and forth on the first gantry assembly along a y-axis, and actuating, via the controller, a second print head, wherein the second print head is supported on a second gantry assembly, the second gantry assembly supported within the machine and adapted to selectively move horizontally back and forth along the x-axis, the second print head adapted to selectively move horizontally back and forth on the first gantry assembly along the y-axis, wherein, the controller is adapted to independently move the first and second print heads along both the x-axis and the y-axis.

According to another aspect, actuating the first and second print heads further comprises controlling, via the controller, movement of the first and second gantry assemblies and the first and second print heads in one of a first, second, third and fourth mode of operation.

According to another aspect, when operating in a first mode of operation, the method includes controlling movement of the first gantry assembly and the first print head while the second gantry assembly and the second print head are idle, and controlling movement of the second gantry assembly and the second print head while the first gantry assembly and the first print head are idle to create a single part.

According to another aspect, when operating in a second mode of operation, the method includes controlling movement of the first gantry assembly and the first print head to create a first part, and simultaneously controlling movement of the second gantry assembly and second print head to create a second part, wherein the first and second parts are identical.

According to another aspect, when operating in a third mode of operation, the method includes controlling movement of the first gantry assembly and the first print head to create a first part, and simultaneously controlling movement of the second gantry assembly and second print head to create a second part, wherein the first and second parts are different.

According to another aspect, when operating in a fourth mode of operation, the method includes simultaneously controlling movement of the first and second gantry assemblies and the first and second print heads to create a single part.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a machine for producing additive printed parts according to an exemplary embodiment of the present disclosure;

FIG. 2 is a perspective top view of a horizontal frame of the machine shown in FIG. 1, wherein first and second gantry assemblies are supported on the horizontal frame and first and second print heads are supported on the first and second gantry assemblies;

FIG. 3 is a perspective bottom view of the horizontal frame shown in FIG. 2;

FIG. 4A is a perspective view of the first gantry assembly;

FIG. 4B is a perspective view of the second gantry assembly;

FIG. 5A is a perspective view of a bellow in accordance with an exemplary embodiment of the present disclosure;

FIG. 5B is a perspective view of a portion of the bellow shown in FIG. 4A where the bellow is compressed;

FIG. 5C is a perspective view of the bellow shown in FIG. 4A where the bellow is expanded; and

FIG. 6 is a schematic flow chart illustrating a method of operating a machine for producing additive printed parts according to an exemplary embodiment of the present disclosure.

### DETAILED DESCRIPTION

The following description is merely exemplary in nature and is not intended to limit the present disclosure, application, or uses.

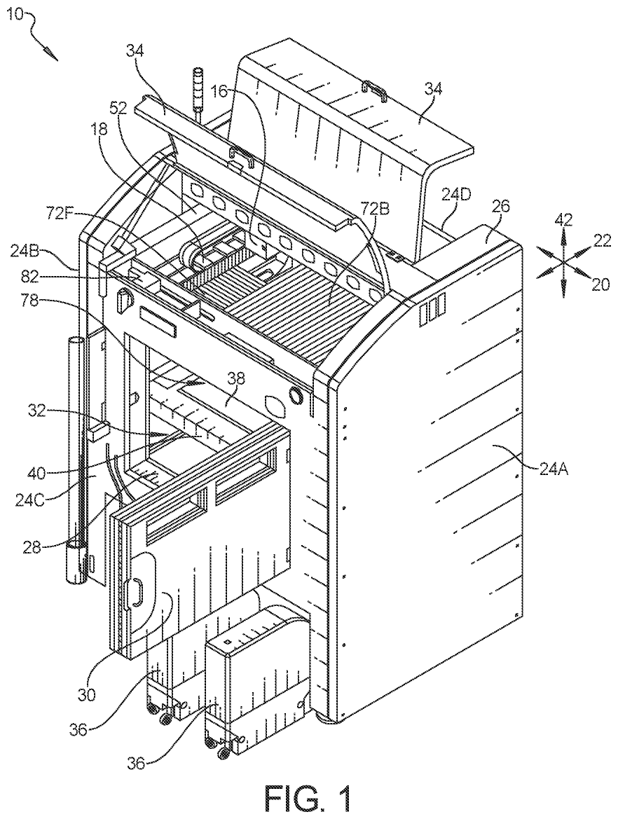

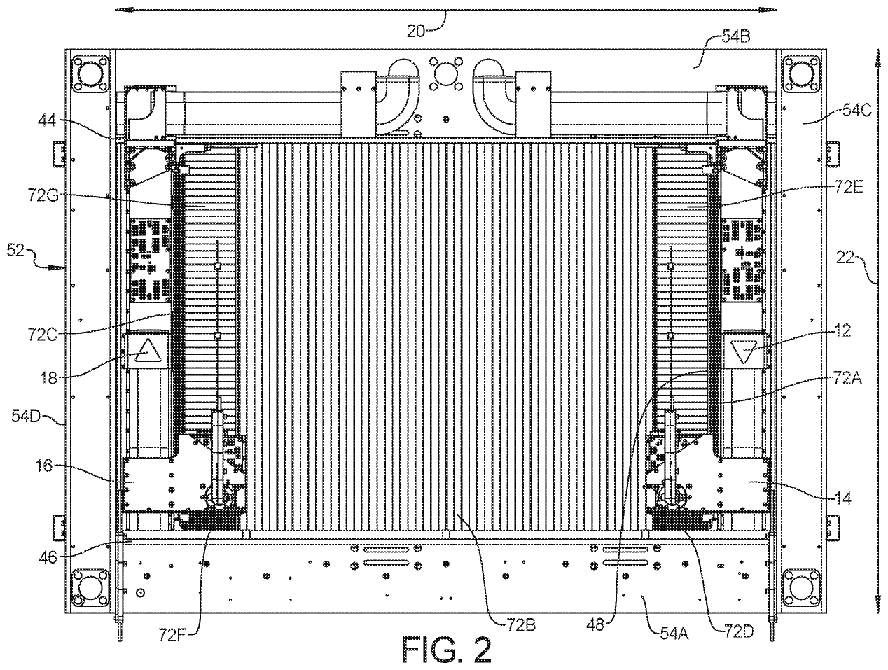

Referring to FIG. 1 and FIG. 2, a machine 10 for producing an additive printed part includes a first print head 12 that is supported on a first gantry assembly 14 and a second print head 16 that is supported on a second gantry assembly 18. The first and second print heads 12, 16 are independently moveable along both an x-axis 20 and a y-axis 22.

The machine 10 includes a first side wall 24A, a second side wall 24B, a front side wall 24C, a rear side wall 24D, and a top 26. The front side wall 24C includes an opening 28 and a door 30 to allow access to an interior space 32. The top 26 includes two hinged doors 34 to allow access to upper portions of the machine 10 and the first and second print heads 12, 16. The first side wall 24A, second side wall 24B, front side wall 24C, rear side wall 24D and the top 26 provide an enclosure for the machine 10 and define the interior space 32 of the machine 10. The interior space 32 of the machine 10 provides a controllable environment for the creation of an additive printed part or parts. During and after creation of the additive printed part or parts, preventing contamination and controlling the temperature of the additive printed part or parts is critical.

Each of the first and second print heads 12, 16 is adapted to feed and deposit a polymer filament to create an additive printed part. In the present example, the machine 10 includes cartridges 36 that house a coil of the polymer filament. The polymer filament is fed to the first and second print heads 12, 16 and the first and second print heads 12, 16 are configured to deposit the polymer material, first onto a print bed 38, and then onto the layers of polymer material already deposited on the print bed 38. Successive layers of the polymer material are deposited until the final shape of the additive printed part or parts is formed. The print bed 38 is mounted onto a top surface of a build table 40. The print bed 38 provides a surface on which the additive printed part or parts will be created. The build table 40 is movable linearly and vertically up and down within the interior space 32 along a z-axis 42 that is perpendicular to both the x-axis 20 and y-axis 22. The movement of the first and second print heads 12, 16 two-dimensionally along the x-axis 20 and the y-axis 22 along with the movement of the build table 40 along the z-axis 42 allows the first and second print heads 12, 16 to produce three-dimensional additive printed parts on the print bed 38.

When the process begins, the build table 40 is positioned high within the interior space 32, very close to the first and second print heads 12, 16. As material is deposited by one or both of the first and second print heads 12, 16 onto the print bed 38, the first and second gantry assemblies 14, 18 move back and forth on first and second gantry support rails 44, 46 along the x-axis 20 and the first and second print heads 12, 16 move back and forth on linear rails 48, 50 of the first and second gantry assemblies 14, 18 along the y-axis 22 to create a two-dimensional shape. The build table 40 moves along the z-axis 42, downward away from the first and second print heads 12, 16 allowing material to be added to the additive printed part or parts along the z-axis 42 and creating a three-dimensional shape.

Referring to FIG. 2, each of the first and second gantry assemblies 14, 18 are supported within the machine 10 and are adapted to independently and selectively move horizontally back and forth within the machine along the x-axis 20. The first print head 12 is adapted to selectively move horizontally back and forth on the first gantry assembly 14 along the y-axis 22, and the second print head 16 is adapted to selectively move horizontally back and forth on the second gantry assembly 18 along the y-axis 22.

The machine 10 includes a generally rectangular horizontal frame 52. The frame 52 includes a front member 54A, a rear member 54B, a first side member 54C and a second side member 54D. The first gantry support rail 44 is mounted horizontally to the rear member 54B adjacent and parallel to the rear member 54B. The second gantry support rail 46 is mounted horizontally to the front member 54A adjacent and parallel to the front member 54A. Each of the first and second gantry assemblies 14, 18 are supported on the first and second gantry support rails 44, 46.

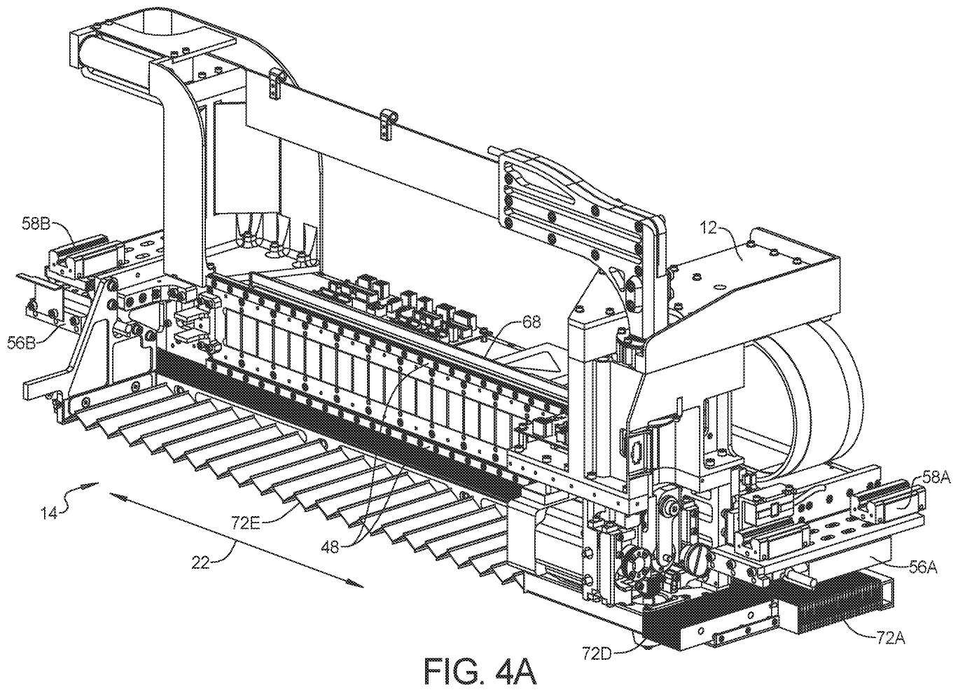

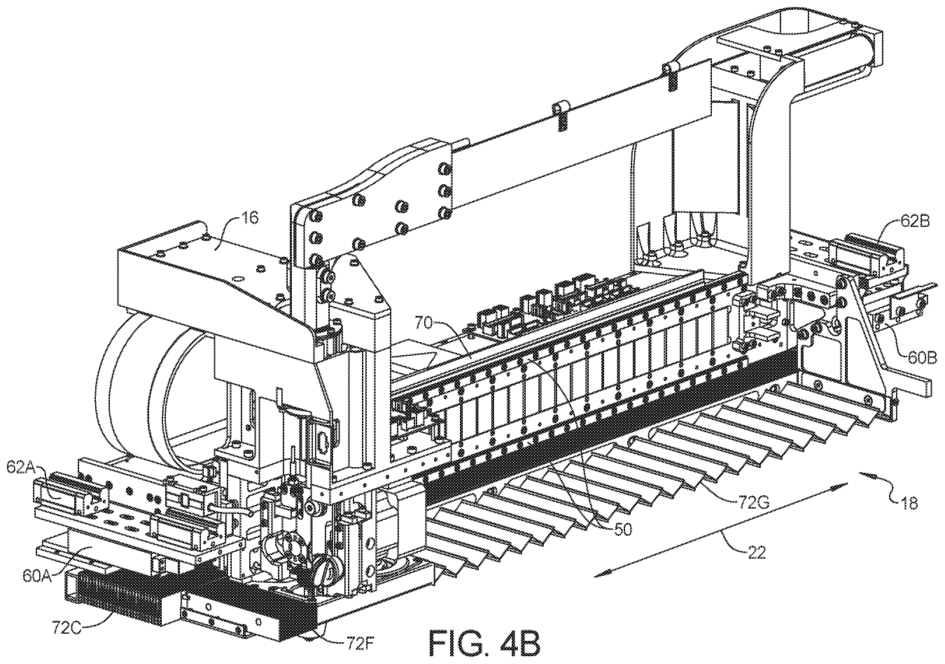

Referring to FIG. 4A, the first gantry assembly 14 includes a first support bracket 56A attached to a first distal end 58A of the first gantry assembly 14 and a second support bracket 56B attached to a second distal end 58B of the first gantry assembly 14. It should be understood that the first and second gantry assemblies 14, 18 are mirror images of one another, having identical components. Referring to FIG. 4B, the second gantry assembly 18 includes a first support bracket 60A attached to a first distal end 62A of the second gantry assembly 18 and a second support bracket 60B attached to a second distal end 62B of the second gantry assembly 18. The first and second support brackets 56A, 56B, 60A 60B of each of the first and second gantry assemblies 14, 18 are adapted to support the first and second gantry assemblies 14, 18 on the first and second gantry support rails 44, 46 for horizontal movement within the machine along the x-axis 20. A mover, such as a servo motor or linear motor may act on one or both of the first and second support brackets 56A, 56B, 60A 60B of each of the first and second gantry assemblies 14, 18 to move the first and second gantry assemblies 14, 18 back and forth within the machine 10 along the x-axis 20.

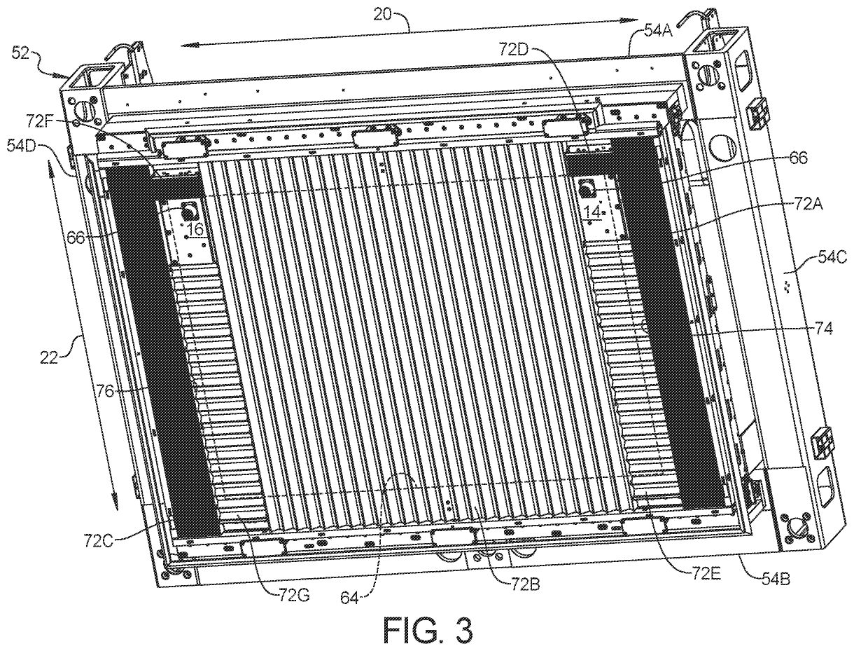

Referring to FIG. 3, the horizontal frame 52 defines a horizontal window 64. The first and second gantry assemblies 14, 18 are supported on the first and second gantry support rails 44, 46 immediately above the window 64. The first and second print heads 12, 16 are supported on the first and second gantry assemblies 14, 18 and each include a nozzle 66 that extends downward through the window 64 to allow the first and second print heads 12, 16 to deposit layers of polymer material onto a part or parts that are being created on the print bed 38 of the machine 10.

In an exemplary embodiment, the first gantry assembly 14 includes an encoder strip 68 mounted thereon. The linear rails 48 are adapted to support the first print head 12 on the first gantry assembly 14 for horizontal movement on the first gantry assembly 14 along the y-axis 22. The encoder strip 68 of the first gantry assembly 14 is adapted to detect the position of the first print head 12 on the first gantry assembly 14. The second gantry assembly 18 is a mirror image of the first gantry assembly 14, and also includes an encoder strip 70 mounted thereon. The linear rails 50 of the second gantry assembly 18 are adapted to support the second print head 16 on the second gantry assembly 18 for horizontal movement on the second gantry assembly 18 along the y-axis 22. The encoder strip 70 of the second gantry assembly 18 is adapted to detect the position of the second print head 16 on the second gantry assembly 18.

The first and second print heads 12, 16 move back and forth linearly on the first and second gantry assemblies 14, 18 along the y-axis 22 that is co-planer and perpendicular to the x-axis 20. Movement of the first and second gantry assemblies 14, 18 along the x-axis 20 and movement of the first and second print heads 12, 16 along the y-axis 22 allows each of the first and second print heads 12, 16 to move two-dimensionally within the horizontal window 64.

In an exemplary embodiment, a plurality of bellows 72A, 72B, 72C, 72D, 72E, 72F, 72G are adapted to allow the first and second print heads 12, 16 to move horizontally on the first and second gantry assemblies 14, 18 along the y-axis 22 and to allow the first and second gantry assemblies 14, 18 to move horizontally on the first and second gantry support rails 44, 46 along the x-axis 20.

A first bellow 72A extends between the first gantry assembly 14 and the first side member 54C to cover the horizontal window 64 between the first gantry assembly 14 and the first side member 54C. A second bellow 72B extends between the first and second gantry assemblies 14, 18 to cover the horizontal window 64 between the first and second gantry assemblies 14, 18. A third bellow 72C extends between the second gantry assembly 18 and the second side member 54D to cover the horizontal window 64 between the second gantry assembly 18 and the second side member 54D. The first, second and third bellows 72A, 72B, 72C are adapted to expand and compress to accommodate horizontal movement of the first and second gantry assemblies 14, 18 back and forth along the x-axis 20, relative to one another and relative to the first and second side members 54C, 54D.

More specifically, when the first gantry assembly 14 moves toward the first side member 54C, the first bellow 72A is compressed between the first gantry assembly 14 and the first side member 54C. When the first gantry assembly 14 moves away from the first side member 54C, the first bellow 72A is expandable between the first gantry assembly 14 and the first side member 54C. Likewise, when the first gantry assembly 14 and the second gantry assembly 18 move toward one another, the second bellow 72B is compressed between the first and second gantry assemblies 14, 18, and when the first and second gantry assemblies 14, 18 move away from one another, the second bellow 72B is expandable between the first and second gantry assemblies 14, 18. Finally, when the second gantry assembly 18 moves toward the second side member 54D, the third bellow 72C is compressed between the second gantry assembly 18 and the second side member 54D, and when the second gantry assembly 18 moves away from the second side member 54D, the third bellow 72C is expandable between the second gantry assembly 18 and the second side member 54D.

The first gantry assembly 14 includes a slot 74 formed therein extending between the first and second distal ends 58A, 58B of the first gantry assembly 14. The nozzle 66 of the first print head 12 extends downward through the slot 74 formed in the first gantry assembly 14. The slot 74 allows the first print head 12 to move horizontally along the y-axis 22 between the first and second distal ends 58A, 58B of the first gantry assembly 14 within the horizontal window 64. Similarly, the second gantry assembly 18 includes a slot 76 formed therein extending between the first and second distal ends 62A, 62B of the second gantry assembly 18. The nozzle 66 of the second print head 16 extends downward through the slot 76 formed in the second gantry assembly 18. The slot 76 allows the second print head 16 to move horizontally along the y-axis 22 between the first and second distal ends 62A, 62B of the second gantry assembly 18 within the horizontal window 64.

A fourth bellow 72D extends between the first print head 12 and the first distal end 58A of the first gantry assembly 14 to cover the slot 74 between the first print head 12 and the first distal end 58A of the first gantry assembly 14. A fifth bellow 72E extends between the first print head 12 and the second distal end 58B of the first gantry assembly 14 to cover the slot 74 between the first print head 12 and the second distal end 58B of the first gantry assembly 14. The fourth and fifth bellows 72D, 72E are adapted to expand and compress to accommodate horizontal movement of the first print head 12 relative to the first and second distal ends 58A, 58B of the first gantry assembly 14.

More specifically, when the first print head 12 moves toward the first distal end 58A of the first gantry assembly 14, the fourth bellow 72D compresses between the first print head 12 and the first distal end 58A of the first gantry assembly 14 and the fifth bellow 72E expands between the first print head 12 and the second distal end 58B of the first gantry assembly 14. When the first print head 12 moves away from the first distal end 58A of the first gantry assembly 14, the fourth bellow 72D expands between the first print head 12 and the first distal end 58A of the first gantry assembly 14 and the fifth bellow 72E compresses between the first print head 12 and the second distal end 58B of the first gantry assembly 14.

A sixth bellow 72F extends between the second print head 16 and the first distal end 62A of the second gantry assembly 18 to cover the slot 76 between the second print head 16 and the first distal end 62A of the second gantry assembly 18. A seventh bellow 72G extends between the second print head 16 and the second distal end 62B of the second gantry assembly 18 to cover the slot 76 between the second print head 16 and the second distal end 62B of the second gantry assembly 18. The sixth and seventh bellows 72F, 72G are adapted to expand and compress to accommodate horizontal movement of the second print head 16 relative to the first and second distal ends 62A, 62B of the second gantry assembly 18.

More specifically, when the second print head 16 moves toward the first distal end 62A of the second gantry assembly 18, the sixth bellow 72F compresses between the second print head 16 and the first distal end 62A of the second gantry assembly 18 and the seventh bellow 72G expands between the second print head 16 and the second distal end 62B of the second gantry assembly 18. When the second print head 16 moves away from the first distal end 62A of the second gantry assembly 18, the sixth bellow 72F expands between the second print head 16 and the first distal end 62A of the second gantry assembly 18 and the seventh bellow 72G compresses between the second print head 16 and the second distal end 62B of the second gantry assembly 18.

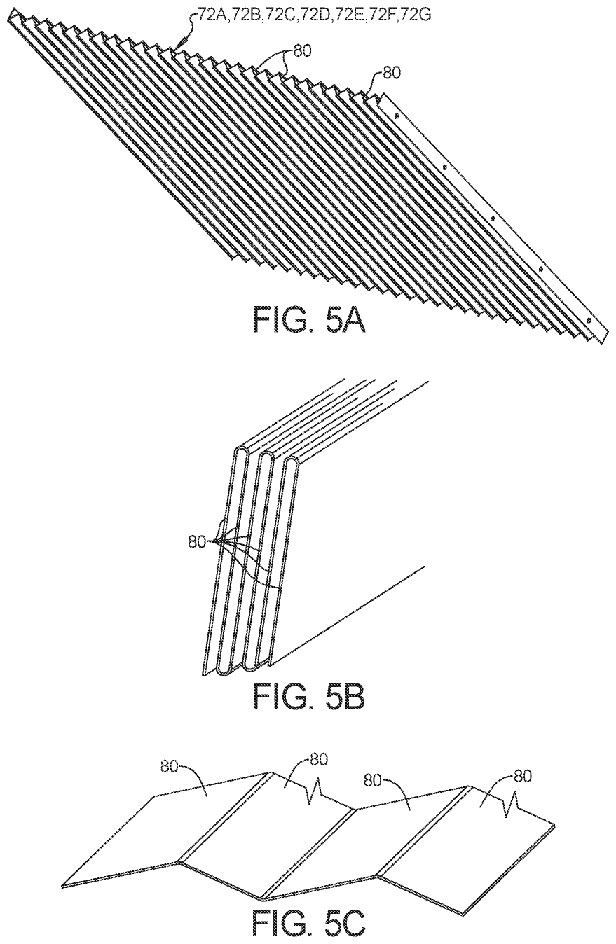

The side walls 24A, 24B, 24C, 24D, the first, second, third, fourth, fifth, sixth and seventh bellows 72A, 72B, 72C, 72D, 72E, 72F, 72G and the build table 40 define a build volume 78 below the horizontal frame 52 within which an additive printed part or parts will be created. Referring to FIG. 5A, FIG. 5B and FIG. 5C, each of the first, second, third, fourth, fifth, sixth and seventh bellows 72A, 72B, 72C, 72D, 72E, 72F, 72G includes a plurality of rigid segments 80 that are flexibly connected to one another at opposing ends. This accordion structure allows the first, second, third, fourth, fifth, sixth and seventh bellows 72A, 72B, 72C, 72D, 72E, 72F, 72G to compress and expand between a situation where the plurality of rigid segments 80 are in close proximity and compressed against one another, as shown in FIG. 5B, and a situation where the plurality of rigid segments 80 are extended out and are nearly linearly aligned with one another as shown in FIG. 5C.

In an exemplary embodiment, the machine 10 includes a controller 82 that is adapted to control movement of the first and second gantry assemblies 14, 18 back and forth on the first and second gantry support rails 44, 46 along the x-axis 20. The controller 82 further is adapted to control movement of the first and second print heads 12, 16 back and forth on the first and second gantry assemblies 14, 18 along the y-axis 22. The controller 82 is a non-generalized, electronic control device having a preprogrammed digital computer or processor, memory or non-transitory computer readable medium used to store data such as control logic, software applications, instructions, computer code, data, lookup tables, etc., and a transceiver or input/output ports. Computer readable medium includes any type of medium capable of being accessed by a computer, such as read only memory (ROM), random access memory (RAM), a hard disk drive, a compact disc (CD), a digital video disc (DVD), or any other type of memory. A “nontransitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

Because the first and second print heads 12, 16 are able to operate independently along both the x-axis 20 and the y-axis 22, the controller 82 can operate the machine 10 in one of four modes of operation. A first mode of operation is known as “Sequential Mode”. When operating in the first mode of operation, the controller 82 is adapted to control movement of the first gantry assembly 14 and the first print head 12 while the second gantry assembly 18 and the second print head 16 are idle, and to control movement of the second gantry assembly 18 and the second print head 16 while the first gantry assembly 14 and the first print head 12 are idle to create a single part. For example, the process would start with the first print head 12 moving two dimensionally and creating layers of a printed part. While the first print head 12 is operating, the second print head 16 is positioned out of the way and idle. At a point during the operation, the first print head 12 moves away from the printed part and the second print head 16 is activated. The process continues with the second print head 16 moving two dimensionally and creating additional layers of material onto the portion of the printed part previously created by the first print head 12. While the second print head 16 is operating, the first print head 12 is positioned out of the way and idle. This mode provides multiple advantages.

Operation in the first mode allows the creation of the printed part to continue when a spool of filament has run out and needs to be changed. If the filament being fed to the first print head 12 runs out, the first print head 12 moves out of the way, and the second print head 16 is activated and continues creation of the printed part while a new spool of filament is installed for the first print head 12. Likewise, operation is the first mode allows two types of filament to be used without requiring creation of the printed part to stop when changing over from one filament type to another. For instance, the first print head 12 may be using a first type of filament and the second print head 16 may be using a second type of filament. When the content of the printed part requires a change from the first filament type to the second filament type, the first print head 12 deactivates, and the second print head 16 is actuated. This is much faster than switching the spools of filament back and forth on a single print head.

A second mode of operation is known as “Copy Mode”. When operating in the second mode of operation, the controller 82 is adapted to control movement of the first gantry assembly 14 and the first print head 12 to create a first part. Simultaneously, the controller 82 controls movement of the second gantry assembly 18 and second print head 16 to create a second part that is identical to the first part. In such a situation, the two parts are positioned side by side on the build table 40, the first and second print heads 12, 16 mirroring each other's movements to create two identical printed parts.

A third mode of operation is known as “Independent Mode”. When operating in the third mode of operation, the controller 82 is adapted to control movement of the first gantry assembly 14 and the first print head 12 to create a first part. Simultaneously, the controller 82 controls movement of the second gantry assembly 18 and second print head 16 to create a second part that is different than the first part. In such a situation, the two parts are positioned side by side on the build table 40, the first and second print heads 12, 16 creating unique two-dimensional layers resulting in two unique printed parts.

Operation in either of the second or third modes offers the advantage of creating two printed parts in the time that would be required to create one printed part when using a machine with a single print head.

A fourth mode of operation is known as “Collaboration Mode”. When operating in the fourth mode of operation, the controller 82 is adapted to simultaneously control movement of the first and second gantry assemblies 14, 18 and the first and second print heads 12, 16 to create a single part. In this situation, the first and second print heads 12, 16 move independently and uniquely within the two-dimensional horizontal plane defined by the x-axis 20 and the y-axis 22, only in this situation, the first and second print heads 12, 16 are working on the same single printed part. This mode of operation allows a single part to be created quicker than if created using just one print head.

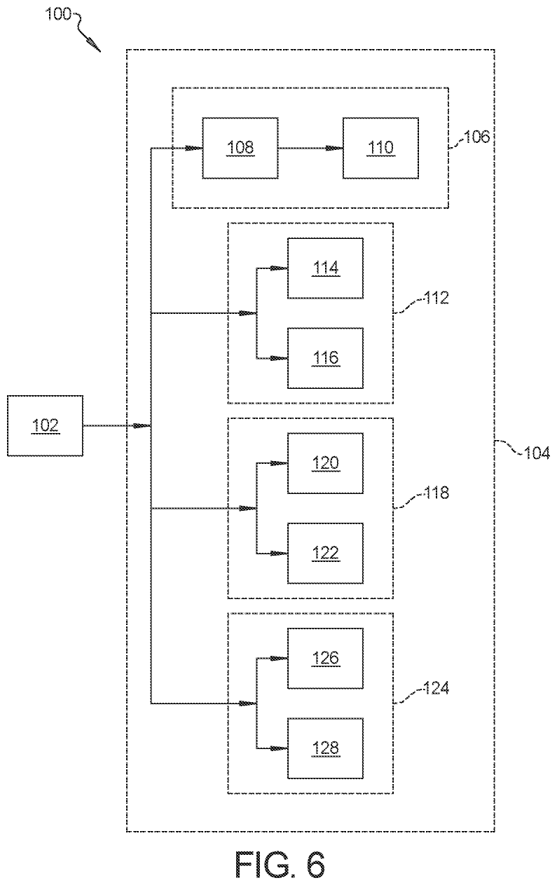

Referring to FIG. 6, a method of operating a machine 10 for producing additive printed parts is shown at 100. Moving to block 102, the controller 82 is adapted to independently move the first and second print heads 12, 16 along both the x-axis 20 and the y-axis 22, the method includes actuating, via a controller 82, a first print head 12, wherein the first print head 12 is supported on a first gantry assembly 14, the first gantry assembly 14 supported within the machine 10 and adapted to selectively move horizontally back and forth along an x-axis 20, the first print head 12 adapted to selectively move horizontally back and forth on the first gantry assembly 14 along a y-axis 22, and actuating, via the controller 82, a second print head 16, wherein the second print head 16 is supported on a second gantry assembly 18, the second gantry assembly 18 supported within the machine 10 and adapted to selectively move horizontally back and forth along the x-axis 20, the second print head 12 adapted to selectively move horizontally back and forth on the second gantry assembly 18 along the y-axis 22.

Moving on to block 104, the method further includes controlling, via the controller 82, movement of the first and second gantry assemblies 14, 18 and the first and second print heads 12, 16 in one of a first, second, third and fourth mode of operation.

Moving on to block 106, when operating in a first mode of operation, the method includes, moving to block 108, controlling movement of the first gantry assembly 14 and the first print head 12 while the second gantry assembly 18 and the second print head 16 are idle, and, moving on to block 110, controlling movement of the second gantry assembly 18 and the second print head 16 while the first gantry assembly 14 and the first print head 12 are idle to create a single part.

Moving on to block 112, when operating in a second mode of operation, the method includes, moving to block 114, controlling movement of the first gantry assembly 14 and the first print head 12 to create a first part, and, moving on to block 116, simultaneously controlling movement of the second gantry assembly 18 and second print head 16 to create a second part, wherein the first and second parts are identical.

Moving on to block 118, when operating in a third mode of operation, the method includes, moving to block 120, controlling movement of the first gantry assembly 14 and the first print head 12 to create a first part, and, moving to block 122, simultaneously controlling movement of the second gantry assembly 18 and second print head 16 to create a second part, wherein the first and second parts are different.

Moving on to block 124, when operating in a fourth mode of operation, the method includes, moving to block 126, controlling movement of the first gantry assembly 14 and the first print head 12, and, moving to block 128, simultaneously controlling movement of the second gantry assembly 18 and the second print head 16 to create a single part.

A machine 10 for producing additive printed parts of the present disclosure offers several advantages. These include reduced downtime needed to switch empty spools of filament when using the machine 10 in the first mode, the ability to use two different filament types for one printed part without experiencing downtime to switch spools of filament when using the machine 10 in the first mode, increased machine output by creating two parts in the time normally needed to make one part when using the machine 10 in the second or third modes, and reduced production time for making parts when using the machine 10 in the fourth mode.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A machine for producing additive printed parts, comprising:
a first print head supported on a first gantry assembly; and
a second print head supported on a second gantry assembly;
wherein, the first and second print heads are independently moveable along both an x-axis and a y-axis.

2. The machine of claim 1, wherein each of the first and second gantry assemblies are supported within the machine and adapted to independently and selectively move horizontally back and forth along the x-axis.

3. The machine of claim 2, wherein the first print head is adapted to selectively move horizontally back and forth on the first gantry assembly along the y-axis, and the second print head is adapted to selectively move horizontally back and forth on the second gantry assembly along the y-axis.

4. The machine of claim 3, further including a generally rectangular horizontal frame including a front member, a rear member, a first side member, a second side member, a first gantry support rail mounted horizontally to the rear member adjacent and parallel to the rear member and a second gantry support rail mounted horizontally to the front member adjacent and parallel to the front member, each of the first and second gantry assemblies supported on the first and second gantry support rails.

5. The machine of claim 4, wherein each of the first and second gantry assemblies includes a first support bracket attached to a first distal end and a second support bracket attached to a second distal end, the first and second support brackets of each of the first and second gantry assemblies adapted to support the first and second gantry assemblies on the first and second gantry support rails for horizontal movement within the machine along the x-axis.

6. The machine of claim 5, wherein the first gantry assembly includes an encoder strip and linear rails mounted thereon, the linear rails adapted to support the first print head on the first gantry assembly for horizontal movement on the first gantry assembly along the y-axis and the encoder strip adapted to detect the position of the first print head on the first gantry assembly, and the second gantry assembly includes an encoder strip and linear rails mounted thereon, the linear rails adapted to support the second print head on the second gantry assembly for horizontal movement on the second gantry assembly along the y-axis and the encoder strip is adapted to detect the position of the second print head on the second gantry assembly.

7. The machine of claim 4, further including a plurality of bellows adapted to allow the first and second print heads to move horizontally on the first and second gantry assemblies along the y-axis and to allow the first and second gantry assemblies to move horizontally on the first and second gantry support rails along the x-axis, the plurality of bellows defining an upper surface of a build volume within the machine.

8. The machine of claim 7, wherein the plurality of bellows includes a first bellow extending between the first gantry assembly and the first side member, a second bellow extending between the first and second gantry assemblies, a third bellow extending between the second gantry assembly and the second side member, a fourth bellow extending between the first print head and a first end of the first gantry assembly, a fifth bellow extending between the first print head and a second end of the first gantry assembly, a sixth bellow extending between the second print head and a first end of the second gantry assembly, and a seventh bellow extending between the second print head and a second end of the second gantry assembly.

9. The machine of claim 8, wherein each of the first, second, third, fourth, fifth, sixth and seventh bellows is adapted to expand and compress to accommodate horizontal movement of the first and second print heads and the first and second gantry assemblies.

10. The machine of claim 9, wherein each of the first, second, third, fourth, fifth, sixth and seventh bellows is an accordion structure comprising a plurality of rigid segments flexibly connected to one another at opposing ends.

11. The machine of claim 4, further including a controller adapted to control movement of the first and second gantry assemblies back and forth on the first and second gantry support rails along the x-axis, and movement of the first and second print heads back and forth on the first and second gantry assemblies along the y-axis.

12. The machine of claim 11, wherein the controller is adapted to control movement of the first and second gantry assemblies and the first and second print heads in one of a first, second, third and fourth mode of operation.

13. The machine of claim 12, wherein when operating in a first mode of operation, the controller is adapted to control movement of the first gantry assembly and the first print head while the second gantry assembly and the second print head are idle, and to control movement of the second gantry assembly and the second print head while the first gantry assembly and the first print head are idle to create a single part.

14. The machine of claim 13, wherein when operating in a second mode of operation, the controller is adapted to control movement of the first gantry assembly and the first print head to create a first part, and to simultaneously control movement of the second gantry assembly and second print head to create a second part, wherein the first and second parts are identical.

15. The machine of claim 14, wherein when operating in a third mode of operation, the controller is adapted to control movement of the first gantry assembly and the first print head to create a first part, and to simultaneously control movement of the second gantry assembly and second print head to create a second part, wherein the first and second parts are different.

16. The machine of claim 15, wherein when operating in a fourth mode of operation, the controller is adapted to simultaneously control movement of the first and second gantry assemblies and the first and second print heads to create a single part.

17. A machine for producing additive printed parts, comprising:
a first print head supported on a first gantry assembly, the first gantry assembly supported within the machine and adapted to selectively move horizontally back and forth along an x-axis, the first print head adapted to selectively move horizontally back and forth on the first gantry assembly along a y-axis; and
a second print head supported on a second gantry assembly, the second gantry assembly supported within the machine and adapted to selectively move horizontally back and forth along the x-axis, the second print head adapted to selectively move horizontally back and forth on the second gantry assembly along the y-axis;
wherein, the first and second print heads are independently moveable along both the x-axis and the y-axis.

18. The machine of claim 17, further including a generally rectangular horizontal frame including a front member, a rear member, a first side member, a second side member, a first gantry support rail mounted horizontally to the rear member adjacent and parallel to the rear member and a second gantry support rail mounted horizontally to the front member adjacent and parallel to the front member, each of the first and second gantry assemblies including a first support bracket attached to a first distal end and a second support bracket attached to a second distal end, the first and second support brackets of each of the first and second gantry assemblies adapted to support the first and second gantry assemblies on the first and second gantry support rails for horizontal movement within the machine along the x-axis.

19. The machine of claim 18, wherein the first gantry assembly includes an encoder strip and linear rails mounted thereon, the linear rails adapted to support the first print head on the first gantry assembly for horizontal movement on the first gantry assembly along the y-axis and the encoder strip adapted to detect the position of the first print head on the first gantry assembly, and the second gantry assembly includes an encoder strip and linear rails mounted thereon, the linear rails adapted to support the second print head on the second gantry assembly for horizontal movement on the second gantry assembly along the y-axis and the encoder strip is adapted to detect the position of the second print head on the second gantry assembly.

20. The machine of claim 18, further including a first bellow extending between the first gantry assembly and the first side member, a second bellow extending between the first and second gantry assemblies, a third bellow extending between the second gantry assembly and the second side member, a fourth bellow extending between the first print head and a first end of the first gantry assembly, a fifth bellow extending between the first print head and a second end of the first gantry assembly, a sixth bellow extending between the second print head and a first end of the second gantry assembly, and a seventh bellow extending between the second print head and a second end of the second gantry assembly, the first, second, third, fourth, fifth, sixth and seventh bellows defining an upper surface of a build volume within the machine, each one of the first, second, third, fourth, fifth, sixth and seventh bellows is an accordion structure comprising a plurality of rigid segments flexibly connected to one another at opposing ends and adapted to expand and compress to accommodate horizontal movement of the first and second print heads and the first and second gantry assemblies.

21. The machine of claim 20, further including a controller adapted to control movement of the first and second gantry assemblies back and forth on the first and second gantry support rails along the x-axis, and movement of the first and second print heads back and forth on the first and second gantry assemblies along the y-axis.

22. The machine of claim 21, wherein the controller is adapted to control movement of the first and second gantry assemblies and the first and second print heads in one of a first, second, third and fourth mode of operation.

23. The machine of claim 22, wherein when operating in a first mode of operation, the controller is adapted to control movement of the first gantry assembly and the first print head while the second gantry assembly and the second print head are idle, and to control movement of the second gantry assembly and the second print head while the first gantry assembly and the first print head are idle to create a single part.

24. The machine of claim 23, wherein when operating in a second mode of operation, the controller is adapted to control movement of the first gantry assembly and the first print head to create a first part, and to simultaneously control movement of the second gantry assembly and second print head to create a second part, wherein the first and second parts are identical.

25. The machine of claim 24, wherein when operating in a third mode of operation, the controller is adapted to control movement of the first gantry assembly and the first print head to create a first part, and to simultaneously control movement of the second gantry assembly and second print head to create a second part, wherein the first and second parts are different.

26. The machine of claim 25, wherein when operating in a fourth mode of operation, the controller is adapted to simultaneously control movement of the first and second gantry assemblies and the first and second print heads to create a single part.

27. A method of operating a machine for producing additive printed parts, comprising:
actuating, via a controller, a first print head, wherein the first print head is supported on a first gantry assembly, the first gantry assembly supported within the machine and adapted to selectively move horizontally back and forth along an x-axis, the first print head adapted to selectively move horizontally back and forth on the first gantry assembly along a y-axis; and
actuating, via the controller, a second print head, wherein the second print head is supported on a second gantry assembly, the second gantry assembly supported within the machine and adapted to selectively move horizontally back and forth along the x-axis, the second print head adapted to selectively move horizontally back and forth on the second gantry assembly along the y-axis;
wherein, the controller is adapted to independently move the first and second print heads along both the x-axis and the y-axis.

28. The method of claim 27, wherein actuating the first and second print heads further comprises controlling, via the controller, movement of the first and second gantry assemblies and the first and second print heads in one of a first, second, third and fourth mode of operation.

29. The method of claim 28, wherein when operating in a first mode of operation, the method includes:
controlling movement of the first gantry assembly and the first print head while the second gantry assembly and the second print head are idle; and
controlling movement of the second gantry assembly and the second print head while the first gantry assembly and the first print head are idle to create a single part.

30. The machine of claim 29, wherein when operating in a second mode of operation, the method includes:
controlling movement of the first gantry assembly and the first print head to create a first part; and
simultaneously controlling movement of the second gantry assembly and second print head to create a second part, wherein the first and second parts are identical.

31. The method of claim 30, wherein when operating in a third mode of operation, the method includes:
controlling movement of the first gantry assembly and the first print head to create a first part; and
simultaneously controlling movement of the second gantry assembly and second print head to create a second part, wherein the first and second parts are different.

32. The machine of claim 31, wherein when operating in a fourth mode of operation, the method includes simultaneously controlling movement of the first and second gantry assemblies and the first and second print heads to create a single part.
